(19) United States
(12) Patent Application Publication
(10) Pub. No.: US 2006/0282186 A1
(43) Pub. Date: Dec. 14, 2006

(54) Optimization of a production process

(75) Inventors: Preben Nordgaard Hansen, Alsgarde (DK); Marek Dariusz Lipinski, Aachen (DE); Marc Christopher Schneider, Aachen (DE); Wilfried Schaefer, Aachen (DE); Jorg Christian Sturm, Aachen (DE)

Correspondence Address: CROCKETT & CROCKETT, 24012 CALLE DE LA PLATA, SUITE 400, LAGUNA HILLS, CA, 92653, US

(73) Assignee: MAGMA Giessereitechnologie GmbH

(21) Appl. No.: 11/438,744

(22) Filed: May 22, 2006

(30) Foreign Application Priority Data
May 20, 2005 (EP) 05010920.6

(51) Int. Cl. G06F 19/00

(52) U.S. Cl. 700/97; 700/197; 700/146

(57) ABSTRACT

A method or system for optimizing a process for producing a cast or molded product made by one or more production steps in respect of one or more predetermined parameters towards one or more optimal values, the process comprising the steps of: defining one or more technical requirements for the cast or molded product; providing a simulation of the casting or molding process; generating with each computer implemented process one or more solutions for the production step concerned that will lead to a cast product that will fulfill the technical requirements; and determining in a further computer implemented process which combination of the individual solutions results in an actual process or in a selected sub-set of production steps in which the predetermined parameter is closest to the optimal value.

This application claims priority European Patent Application 05010920.6, filed May 20, 2005.

### FIELD OF THE INVENTIONS

The present inventions relate to the field of design optimization and production planning in order to obtain cost effective and/or resource effective production of parts, in production processes related to the production of cast products such as metallic castings and injection molded plastic parts. The present inventions also relate to methods or systems which provide for coupling quantitative casting property predictions and casting design optimization loops with the optimization of local material requirements during component design, thereby improving the final design.

### BACKGROUND OF THE INVENTIONS

Since the 1960's the digital computer has steadily been used more and more intensively to simulate different procedural aspects and phenomena in manufacturing processes. This development has intensively been supported by the continuous increase in computer power over the years. Today enough computer power is available at low cost to be able to carry out exceedingly complex and comprehensive simulations. What has been known and used thus far through the use of simulation software has resulted in sub-optimization of different technical casting process production aspects.

For example, the textbook entitled: “Numerical Simulation and Modeling of Casting and Solidification Processes for Foundry and Cast-House”, authored by Peter R. Sahm and Preben N. Hansen, published by Comite International des Associations Techniques de Fonderie, International Committee for Foundry Technical Associations, CIATF 1984 (hereafter referred to as “Hansen et al.”), long ago described how to carry out simulation of casting processes to be able to design a casting layout and a casting process which would lead to castings with what was then a sufficient particular quality level for a particular characteristic of the casting. Further, Marek Dariusz Lipinski, disclosed a substantially similar methodology, though providing greater detail, especially for the mold filling process, in a Ph.D. dissertation “Mold Filling Simulation for Casting Processes”, Technical University, Aachen, Nov. 4, 1996 (hereafter, “Lipinski”).

Over the ensuing years many articles have been published on how to simulate and attempt to optimize, i.e., endeavoring but only ultimately sub-optimizing, different process aspects in casting processes. A series of conferences with proceedings have been held, including: “Modeling of Casting, Welding and Advanced Solidification Processes” held by The Engineering Foundation, U.S.A.

These ideas from 1984 forward have been commercialized in software products like MAGMASOFT® software for metal casting processes, where it is possible to simulate the filling process to be able to design a proper gating system and a correct way to fill a casting. Further, the solidification process can be simulated to be able to check if the quality is satisfactory, as for example, in checking to determine whether the microstructure and the mechanical properties are acceptable and fulfilling the specifications as well as to check if any faults are to be expected in the casting process. Further it is possible to simulate the stresses which are generated in the different steps in casting and heat treatment processes to check whether these are acceptable or not.

Also in the field of plastic injection molding simulation, activities have been undertaken with software products like SIGMASOFT® software, a software product like MAGMASOFT® software having a plastics database and a user interface, and the Moldflow software product, inter alia. Peter Kennedy has also published some specific ideas for plastics in the book “Mold Filling of Injection Molds,” Hanser Publishers, 1995.

It may be fair to summarize the main aim of using simulation prior to the advent of the present invention in that it had been to improve the quality of cast metallic and plastic parts to be able to meet a particular one or more quality specifications; noting even so that such specifications may generally have been steadily increasing. Then when a particular pre-defined quality level had been sufficiently obtained in the resulting end-product, the goal had been reached and the simulation was not taken any further.

### SUMMARY

A method for optimizing a process for producing a cast or molded product made by a number of production steps in respect of a predetermined parameter towards an optimal value, the process comprising the steps of defining one or a number of technical requirements for the cast or molded product; providing computer implemented processes that each reflect one of said production steps; generating with each of the computer implemented processes a number of solutions for the production step concerned that will lead to a cast product that will fulfill the technical requirements; optionally selecting a set of production steps, and determining in a further computer implemented process which combination of the individual solutions results in an actual process or in a selected set of production steps in which the predetermined parameter is closest to the optimal value.

This method allows the overall process to be optimized towards a given parameter, such as the lowest manufacturing cost, the overall energy consumption, the lowest material consumption, or the lowest environmental load, shortest lead time inter alia. The process takes the interrelation between the process steps into account and can thus deduce the optimal solution towards a given parameter.

The optimized method can than be fed back into the respective overall production process to thereby provide input to the manufacturing machinery for the respective manufacturing sub-steps.

### BRIEF DESCRIPTION OF THE DRAWINGS

FIG. 1 is a flow chart diagram illustrating a method for optimizing a process for producing a cast product;

FIG. 2 is a flow chart diagram illustrating a casting process simulation procedure and phenomena to be simulated;

FIG. 3 is a general routing diagram illustrating a manufacturing optimization procedure;

FIG. 4 is a manufacturing routing diagram for a casting manufacturing process illustrating an optimization methodology;

FIG. 5 is a flow chart for the collection of data for an optimization method and software;

FIGS. 6a-6d provide respective isometric and cross-sectional views of a first configuration of a casting part;

FIG. 7 is a cross section of a second configuration of a casting and core;

FIG. 8 is a cross section of a third configuration of a casting with no core used;

FIG. 9 is a cross section of a fourth configuration of a casting and two cores;

FIG. 10 is a cross section of fifth configuration with a casting and three cores;

FIG. 11 is a first layout with a horizontal parting for the first configuration;

FIG. 12 is a second layout with a horizontal parting also for the first configuration;

FIG. 13 is a first layout with a vertical parting for the first configuration;

FIG. 14 is a second layout with a vertical parting for the first configuration;

FIG. 15 is a process diagram of an alternative configuration of a design process incorporating casting analyses;

FIG. 16 is an alternative view of a process diagram for an alternative configuration incorporating casting analysis with a design process;

FIG. 17 is a cast component, the design of which may be optimized;

FIG. 18 is a load diagram depicting loading of a cast component;

FIG. 19 is a mold filling simulation;

FIG. 20 is a solidification simulation;

FIG. 21 is a simulation of a distribution of micro-structures in a cast part;

FIG. 22 is a simulation of defects such as porosities;

FIG. 23 is a simulation of yield strength;

FIG. 24 is a simulation of elongation;

FIG. 25 is a simulation of residual stresses;

FIG. 26 is a simulation of risering;

FIG. 27 is a simulation of gating;

FIG. 28 is a methodological pathway alternative;

FIG. 29 is another alternative methodological pathway alternative; and

FIG. 30 is a further alternative methodological pathway alternative.

### DETAILED DESCRIPTION OF THE INVENTIONS

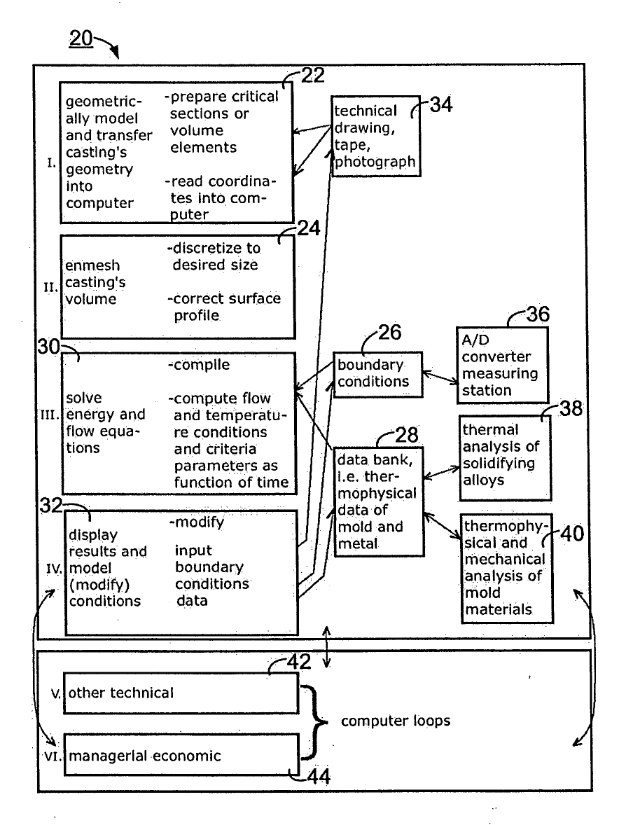

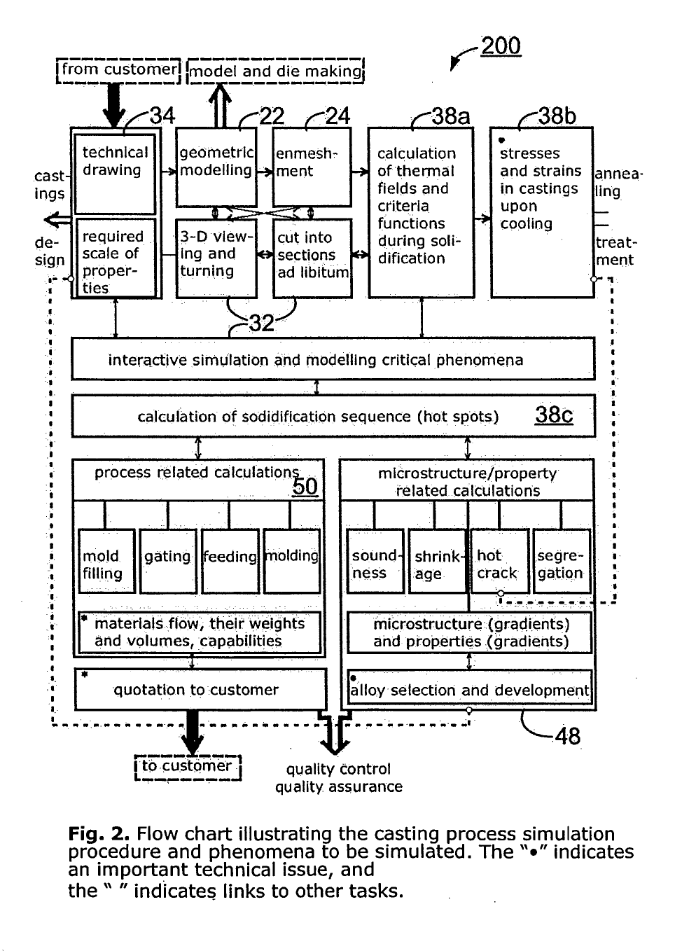

In FIGS. 1 and 2 a review of the different elements necessary to carry out a numerical simulation of casting processes is illustrated. The main steps of a simulation identified generally using the reference numeral 20 (see FIGS. 1 and 2) are the following:

A digital geometrical representation of the geometry of the simulation domain, see box 22;

Enmeshment, which is subdivision of the calculation domain into many small elements, which are the bases for discretizing the differential equations (utilizing different solution algorithms) and in this way finding the solutions to the physical phenomena to be simulated, see box 24;

Specifying the boundary conditions for the simulation project, see box 26;

Attaching the necessary physical data for the different materials domains into the simulation model (data base or data bank), see box 28;

Solving the differential equations for heat flow, fluid flow and stresses and strains using numerical algorithms, see box 30; and

Displaying the results, see box 32.

As further shown in FIG. 1, various other elements may contribute to the overall process; as for example, first having technical drawing data, see box 34, particularly in electronic form, this data (and/or graphics, etc.) can be fed into the process, particularly at the first step 22, providing a geometrical representation of the ultimate part to be cast.

Similarly, other information may be fed, particularly in digital form, into the process. Such is shown for example by the feeding of measurement data, via an A/D converter, see box 36, into the boundary condition definition. Or, other analyses can be performed with the results fed into the overall process; examples here being shown by boxes 38 and 40 representing respectively a thermal analysis of solidifying alloys or a thermophysical and/or mechanical analysis of mold materials. Moreover, still further technical and/or administrative (e.g., managerial, financial and/or economic) data could be incorporated into the overall process as is indicated generally by the boxes 42, 44, in FIG. 1.

Still furthermore, several aspects and related models can be coupled to and/or expanded from within one or more of the otherwise discrete steps of this main simulation structure 20 as shown in a further detailed example of a casting simulation process 200 in FIG. 2. See e.g.:

Criteria functions, which may combine in different formulas the parameters, which are the result of the simulation to be able to predict different phenomena, as for example the three solidification/thermal/cooling calculations 38a, 38b and 38c broken out (figuratively and/or actually) from a single set of calculations 38 in FIG. 1; and/or as for a further example, the additional microstructure calculations such as porosity formation, shrinkage formation, crack formation, erosion phenomena, cold shots, etc., all generally indicated by the box 48 in FIG. 2;

Micro modeling of the formation of the microstructure during solidification of castings and during heat treatment of castings, box 38a, e.g.; and

Models for simulation of stresses and strains, box 38b, e.g.

Additional and/or further broken out detailed calculations related to the overall process may also be included as is suggested generally by the box 50, which here may include the functionality of the box 40 of FIG. 1. Note also that all reference identifications (numerals) are intended to show similarity, not necessary identity of functionality(ies) throughout the discrete figures, as e.g., between FIG. 1 and FIG. 2. Thus, for example, the three boxes identified with a 32 in FIG. 2 are intended to demonstrate different display functionalities, not unlike, but in no way limitative of the functionalities more generally indicated in FIG. 1. Similarly, note that the calculations of box 30 in FIG. 1 may be understood to be distributed throughout numerous of the boxes of FIG. 2, and are thus not separately identified herein. Other add-on modules with more specific functionalities may also or alternatively be added into/onto an overall process 20 or 200 as well. Non-limitative examples, such as iron, steel, HPDC, LPDC and/or plastic injection molding add-on modules may be used, details of exemplary such modules being set forth hereinbelow.

In any case, in both figures, FIGS. 1 and 2, it can be seen that a way to find the wanted technical process solution may include using human iteration where new simulation runs may be carried out after changing either the geometry, and/or the boundary conditions, and/or the thermophysical data, etc. Such a procedure can then be iteratively carried out any number of times until the user decides that a satisfactory solution is found.

However, as in other areas of leading edge development today, a further preferable means may include having a software program using an algorithm (in some instances, a substantially generic iteration algorithm) to carry out these iteration loops where a criterion is selected for the optimal solution (e.g., component or process cost or a particular material or a particular end quality criterion), so that it is no longer human iterations but automatic iterations on the computer, which finds the best technical solution for a given phenomena.

Then, as a further developed option to support the user in deciding for and selecting the best solution for him, one or a plurality of criteria may be selected and run in parallel so that the results from the one or a plurality of technical simulation runs can be presented to a human operator at the same time. Then, it may be easier for the human user to see which one of the potential one or more solutions may provide the best solution in a particular case. One means for achieving such an operation may include working in a scheme referred to as VTOSO (i.e., a “Virtual Try Out Space®” a sort of “Virtual Reality”), the results from all the technical simulation runs being presented on a computer display (e.g., on a screen) at the same time. The human user may then select which one of the potential one or more solutions may provide the best solution in a particular case.

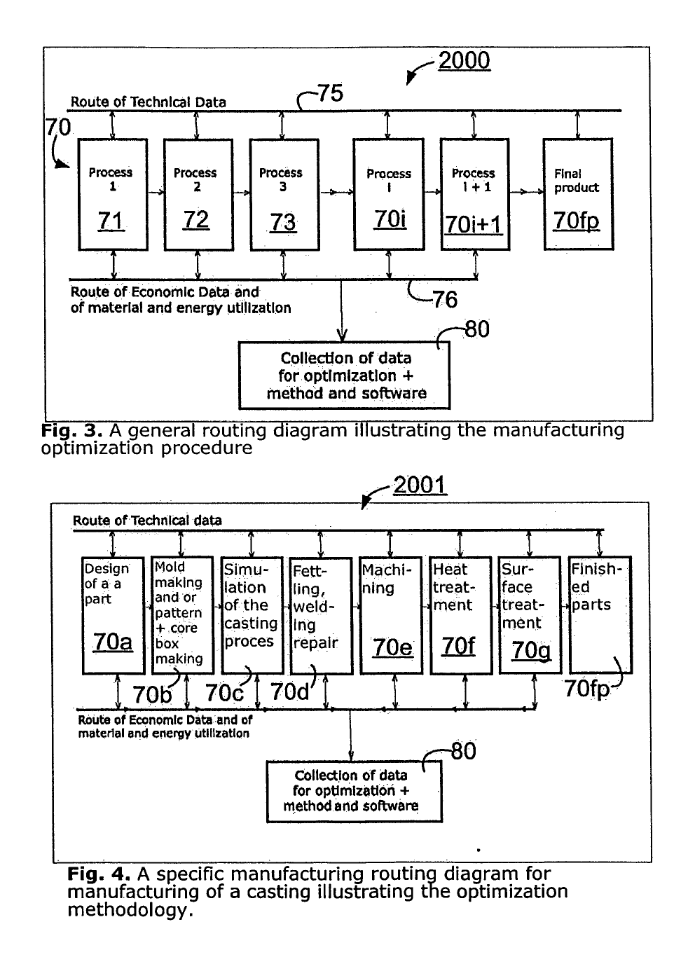

Examples of methodologies running in such a parallel or substantially simultaneous fashion are shown in FIGS. 3 and 4 (note, the “parallel” or “simultaneous” phraseology is intended for descriptive purposes of preferred embodiments only; these terms are not intended to limit the methodologies to absolute parallelism or simultaneity as the relative timings of the individual sub-processes may not be concurrent or may occur in staggered or piecemeal fashions as well). FIGS. 3 and 4 show substantially the same methodological structure; however, where FIG. 3 retains a generalized or generic scheme, FIG. 4 has taken on sub-processes useful in metal or plastic castings as a specific example of the generalized process.

In looking first more specifically at the generalized form of FIG. 3, the overall process, identified here with the numeral 2000 has one or a plurality of sub-processes, generally identified as sub-processes 70. As shown, these sub-processes may include specified sub-processes 71, 72 and 73, for example; and/or may further include any number of sub-processes 70i and/or 70i+1. Moreover, the completion of the finished product may be identified as well as the “step” 70fp even if such a step is not entire “sub-process” itself, marking instead merely the completion of the overall process 2000. Similarly, any one or more of the sub-processes 70 may also not necessarily include entire sub-processes; rather only including a single step, or mere transition to another step or separate sub-process.

Then, still in FIG. 3, it can be noted that separate channels for data input, see e.g., technical data input line 75 and economic/material/energy data input line 76, may be connected to each of the sub-processes 70. These may actually be separate data input lines, or they may actually be a common line, as in a common serial bus connection, or other common data input/output connection, or there may be one or more further separate lines providing the data connections to the appropriate sub-processes. Similarly, it may be that the data lines are not connected to each and every sub-process, rather only those to and/or from which data is to be communicated (e.g., it may be that not all sub-processes will have an economic data tie). In any case, it may also be noted that the two way arrows connected herebetween are intended to show the preferability that data be provided in either direction so that input may be taken in for the sub-process to calculate an output value which may then be communicated back, e.g., via the technical data line 75 to another sub-process which may then use that calculated data to reach another particular result. Note, arrows directly between sub-processes are shown also to indicate the possibility that sequential transition between any two or more sub-processes directly may be used herein as well; however, such is not necessary, where indeed, more substantial parallel and/or piecemeal back-and-forth transactions may be performed.

In any case, the ultimate conclusions of any one or more sub-processing will preferably be communicated to the optimization sub-process 80, wherein the results may individually be evaluated and/or displayed for ultimate use/decision by the human user. In a VTOS model, one or a preferable plurality of sub-processing results may be displayed substantially simultaneously (even if not necessarily achieved simultaneously), or sequentially, for review and comparison by the human operator and ultimate decision-making thereby. Thus, step 80 may include one or more display steps. This iteration may be performed by the operator or by a computer implemented algorithm.

The more specific example 2001 in FIG. 4 of such a generalized model 2000, includes example sub-processes 70a -70g for a metal or plastic casting process. More particularly, these example sub-processes include, without limitation hereto, a design sub-process 70a, a mold/pattern/box making sub-process 70b, a casting simulation sub-process 70c, fettling sub-process 70d, machining 70e, heat treatment 70f and a surface treatment sub-process 70g. These are described in further detail herein below. This is but one example of a collection of sub-processes. Desirably then, based upon one or more certain input data, as for example, certain preferred technical and/or economic data, one or more conclusions are reached and communicated to the sub-step 80 for optimization. Note, a plurality of alternative input data sets may be used to generate a corresponding plurality of output conclusion sets for ultimate use in comparison by the user/operator as for example in a VTOS or virtual reality operation at box 80, e.g.

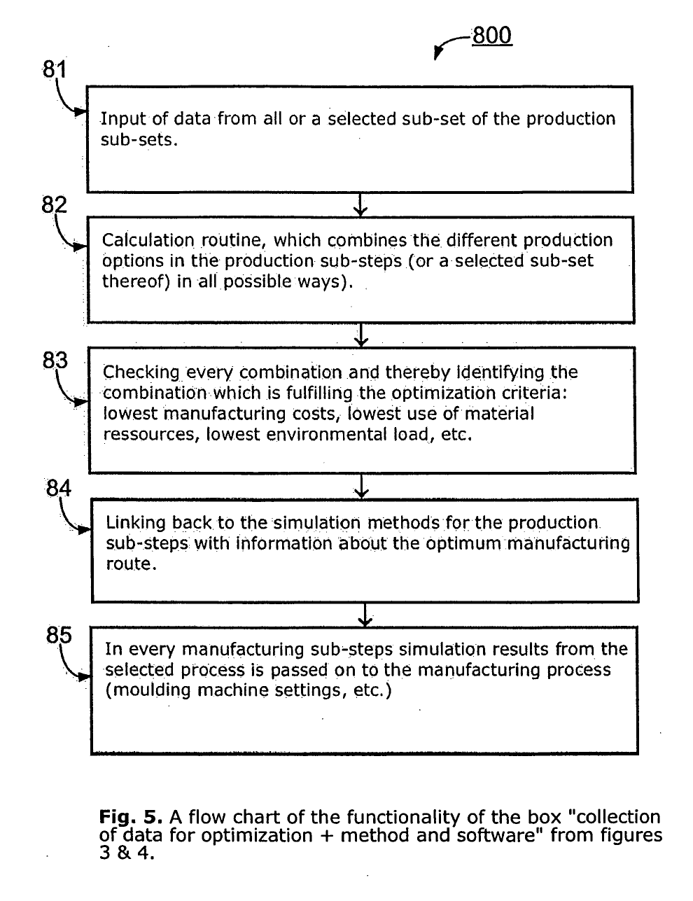

Note, the optimization methodology, which so far in the FIGS. 3 and 4 has been illustrated by example with the box 80 “Collection of data for optimization +method and software,” may take various forms, as for example the display function suggest above. However, such a sub-process 80 may take a form such as is shown by the sub-process 800 in FIG. 5 including more elaborate functionality, i.e., may include more sub-steps. The FIG. 5 example methodology 800 may thus start at substep 81 with data input from the production sub-steps for different possible ways of manufacturing in every sub-step (or a selected sub-set thereof).

After this, in steps 82 and 83, one or more or all possible combinations of the different ways of manufacturing in the different sub-steps/sub-processes 70 (sub-steps and sub-processes are used interchangeably herein) are analyzed related to the optimization criterion, which can be the lowest manufacturing cost, the lowest materials consumption, the lowest environmental load, etc., or any combination hereof. Doing this the most optimal manufacturing route can be found.

This can be followed in steps 84 and 85 by giving this information back to the different manufacturing sub-steps/sub-processes (step 84) to be used (via the simulation results) to give input to the actual manufacturing machinery (step 85) for the different manufacturing sub-steps.

A result may be a desirable methodology for design optimization and production planning setting the frame for cost effective and/or resource effective production of parts, especially metallic castings and injection molded plastic parts.

As is described herein, this numerical simulation technique may thus be commercialized to be a turnkey solution, which is very user friendly, fast, comprehensive and accurate, which may include features like:

Completely menu driven user interface;

Project management module;

Pre-processor including solid geometry modeling, CAD data transfer to and from other and conventional CAD-systems and automatic enmeshment;

Simulation modules for process description (fluid flow, solidification and heat transfer, stresses and strain, microstructure development in solidification and heat treatment processes) and solution algorithms to solve the physical equations and provide (via simulation runs) the simulation results;

Post-processor for 3D visualization and evaluation of results;

Thermo-physical data base;

Software releases for single processor computers, dual processor computers and multi processor computers (Cluster technologies);

Special add-on modules for specific casting processes: HPDC-module for simulating the high pressure die casting process, LPDC-module for simulating the low pressure die casting process, DISA®-module for simulating the DISAMATIC® casting process, Iron-module for simulating the solidification of iron casting processes, Steel-module for simulating the specifics of steel casting processes, Stress-module for simulating stresses and distortions in casting processes, Cosworth-module for simulating the specifics of the Cosworth casting process, etc.; and

Software for automatic initiation of the simulation iteration loops using generic algorithms and criterions to automatically select the optimal technical solution.

The pre-processor can include solid geometry modeling, CAD data transfer and automatic enmeshment. This enables an easy and fast geometry description of complex shaped castings and mold geometries. All parts of the geometry can be manipulated. This allows rapid modifications of the gating and feeding system based on the results of previous simulation runs. To facilitate the design of cooling channels in permanent molds, feeding sleeves and chills and the easy construction of a multiple cavity permanent mold (or die), standard components can be saved and loaded from a database. Optionally available general and direct interfaces like STL allow external generated geometries constructed within different CAD systems to be read into the pre-processor. An automatic enmeshment functionality allows for creation of a sound enmeshment in minutes. The user defining global control parameters can adjust accuracy and coarseness of the mesh.

Simulating mold filling allows the investigation of the filling pattern in both dies, permanent molds, sand molds and around cores for all shape casting processes; mainly by solving the Navier-Stokes equations coupled with the energy equation in a way, which was described in above-cited literature references of Hansen et al., Lipinski and Kennedy. The following information may thus be obtained:

Mold filling pattern;

Metal/plastic velocities in the die or mold cavity

Loss of superheat and temperature distribution during mold filling; and

Potentials for cold shots, cold laps, flow lines and possible sand erosion during filling and the likelihood of gas entrapment and entrainment.

This type of information assists the foundryman in the following objectives:

Optimizing the gating system;

Prediction of sand erosion and penetration due to critical velocities in the melt;

Determination of filling times dependent on the gating system, pouring/filling rates or pressure in bottom stopped ladles

The optimal placements of overflows in die casting

Investigation of turbulences, splashes and “hammer effects” within the melt causing entrapment of slag, air inclusions and droplet generation at the flowing melt front;

The use of filters.

Simulating heat flow and solidification is a powerful tool for the investigation of casting solidification and cooling. It takes into account liquid and solid contraction and shows the feeding of the casting and porosity formation and provides information about:

Solidification patterns and feeding paths;

Solidification times, temperature gradients and cooling rates at all points of the casting;

Critical regions in the casting;

Thermal loading of dies, cores and molds (to be used as load input to the following calculations of stresses, strains and distortions such as segregations and inclusions); and

Cooling curves at any location within the casting, mold or die.

This kind of information assists the foundryman in the following objectives:

The optimal methoding of castings and the layout of permanent molds and dies, and the pattern- and core box design for sand casting processes

The use of feeders and feeding aids, minimization and effective use of chills

Investigation of process conditions such as optimal time to remove the casting, cooling needs of the mold material, deterioration of molding sand and related gas evolution, effect of chilling, heat impact to cores resulting in deterioration and gas evolution

Provides quantitative feeding needs for any feeder

Provides insight to methoding changes seeking to remove porosities and shrinkages.

The batch functionality provides the capability of modeling multi-cycle casting processes in permanent molds and provides information about:

The temperature distribution within the casting and permanent molds at any time.

The number of casting cycles needed to reach the “steady state” production conditions in the start up production phase, where the permanent molds are heated to the “steady state” thermal production balance. The associated change in the quality of the cast part can also be observed.

Optimal casting removal time (for a given removal temperature).

This batch functionality supports the following objectives:

Optimal manufacturing conditions for permanent mold and die casting processes;

Optimal layout of dies and cooling and heating channels;

The minimization of cycle times by the identification of the earliest casting ejection time;

Pin-pointing of critical areas in the die where; thermal loading is critical and could reduce die life;

The achievement of constant casting quality; and

General process understanding.

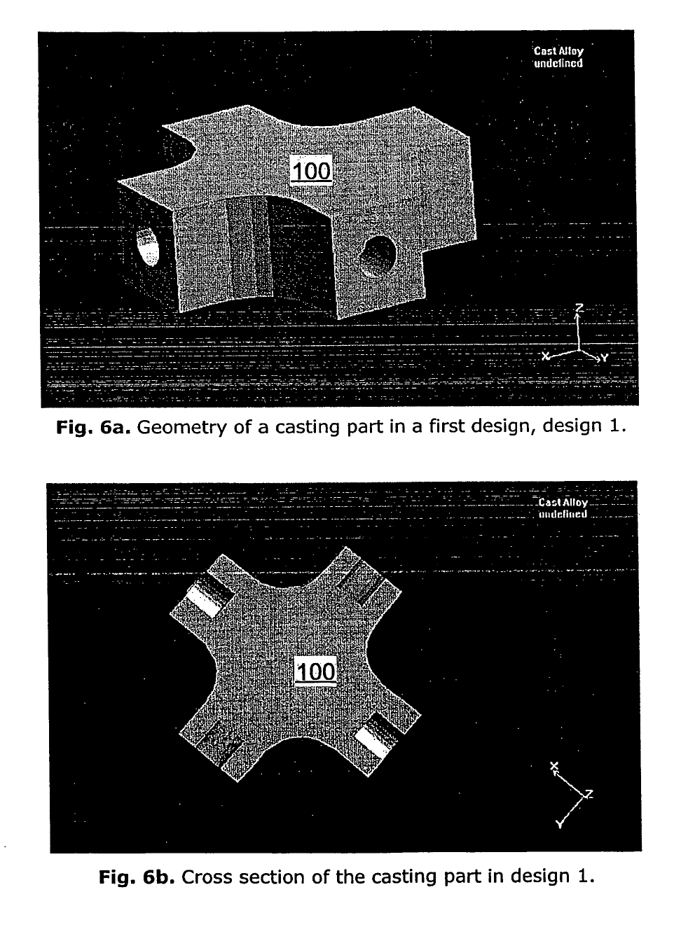

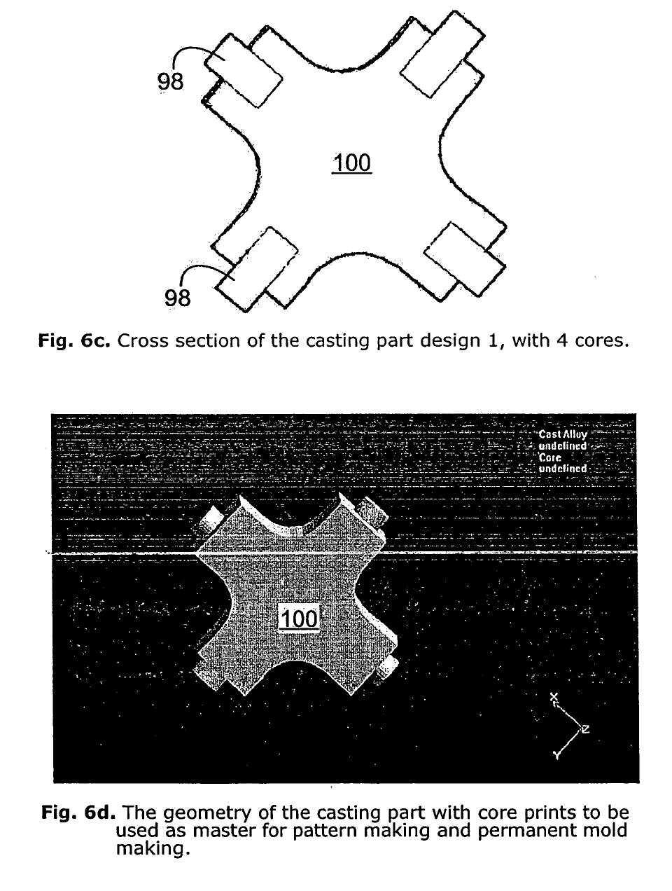

In post-processing, there can be obtained a 3D visualization and evaluation of results (see FIG. 2, and FIGS. 6-14 e.g.). The 3D post-processor allows the user to view the results from any direction and slice through the results from any direction and to slice through certain areas, thereby identifying critical areas of the casting. Temperatures in the casting and mold can be viewed at any stage of the casting process. Porosity levels, the filling pattern as well as the thermal history can be pinpointed and viewed as an X-ray film too. Various criteria (criteria functions) help the user to condense the information from filling, solidification or feeding with one comprehensive picture. Cooling curves, velocity, pressure, stresses and strains can be shown at any location.

The data base module may provide the user with the necessary thermophysical data to perform the simulation runs. The user may then have the option to add or make changes to the thermophysical data sets for different alloy compositions or materials and to assign them to different databases. Process conditions and the geometry of different objects (feeders, feeder sleeves, filters, gating systems, etc. can be stores as required).

FIGS. 6-14 show graphic examples of optimization variables relative to a particular cast product as discussed herein. In particular, FIG. 6 initially provides views of a cast product 100 which could be of any shape, but for our purposes is a shape which includes one or more intentionally formed voids as defined by cores 98 in FIG. 6. Note, as shown in FIG. 6c, four cores 98 are used to form corresponding voids in the cast product 100. Further description of the product of FIG. 6 will be addressed below.

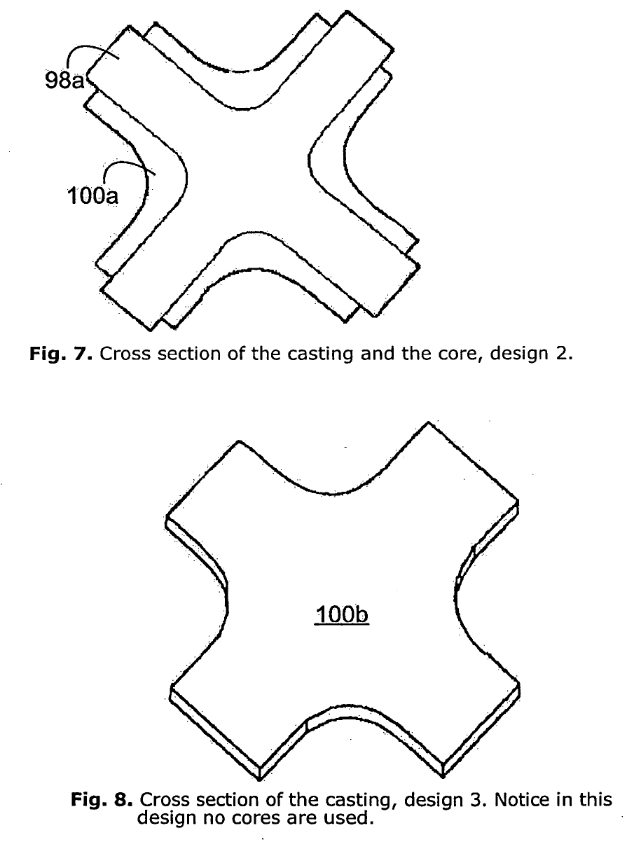

However, first several alternative cast products will first be described beginning with the product 100a of FIG. 7 which has a single multi-armed core 98a used to form similar voids in the end product 100a. A similar, though voidless product 100b is shown in FIG. 8 (the four voids are to be machined in a machining process). The primary point in showing such alternative structures is to highlight various forms providing similar end-products recognizing that different internal or other constraints may be used in their formation, noting even so that the different forms, including the different cores can an will have various impacts on the resulting products. Some will be easier to make. Others will use more or alternatively less material (in some cases more will be better, as for example to make a stronger product; whereas in other cases, more material will seem a waste in that the strength will not be advantageous).

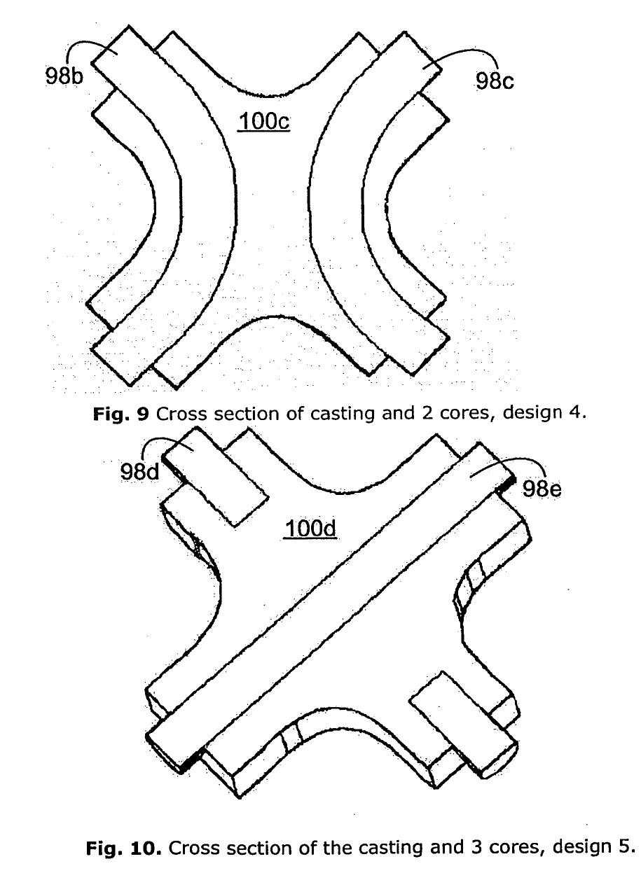

Still further alternatives in the same fashion are shown in FIGS. 9 and 10, where for example, an end-product 100c is shown in FIG. 9 with two cores 98b and 98c (these perhaps simplifying one aspect of production, while perhaps simultaneously increasing complexity of another aspect); and where an alternative end-product 100d is shown in FIG. 10, this example including three cores, represented by cores 98d and 98e. The FIG. 10 example may thus simplify the FIG. 6 example in requiring fewer parts (three cores versus four cores); however, there may be increased complexity involved in removing such an elongated core 98e, or perhaps a trade-off in reduced end-product mass, thus off-setting strength, inter alia.

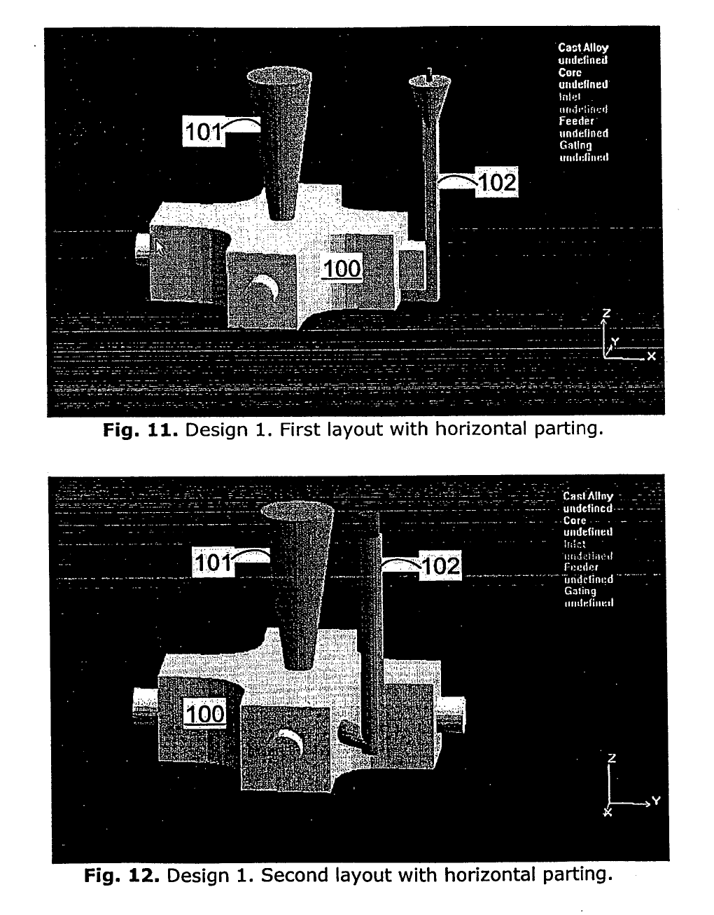

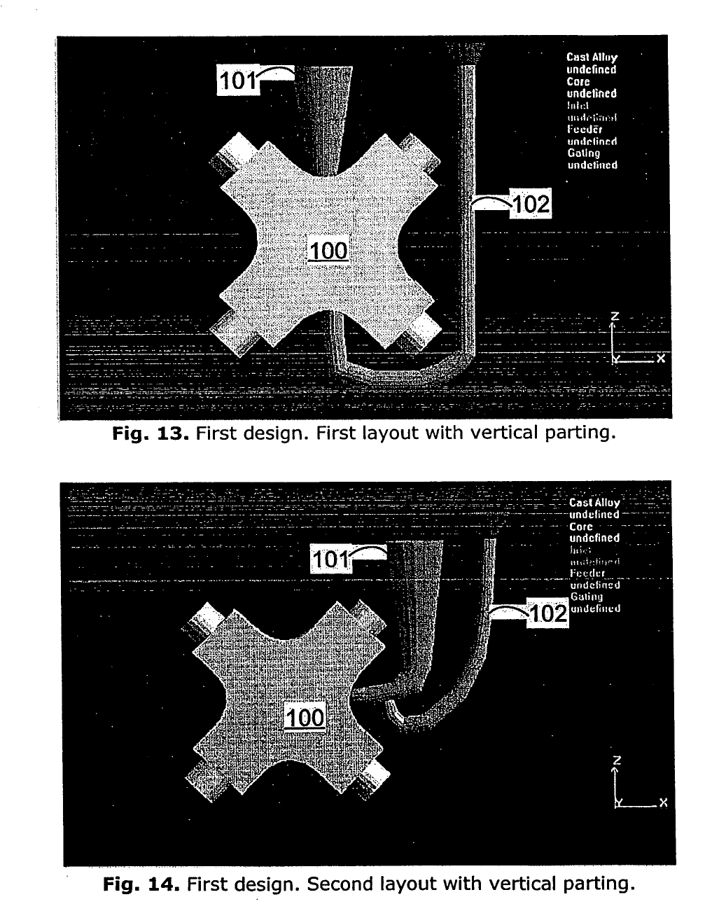

Moving to the examples of FIGS. 11-14; four alternative molding processes are shown; each of these having various trade-offs in either functionality or end quality, inter alia. In FIG. 11, a first molding process is shown for formation of an end-product 100 (as in the first design 100 of FIG. 6 (with four cores)). Here, a horizontal parting is shown with a central feeder 101 and an underside inlet 102. An alternative second horizontal parting is shown in FIG. 12 with again a central feeder 101, but with a lateral/side inlet 102. Then, in FIGS. 13 and 14, alternative vertical partings are shown for a substantially similar end-product 100; in these cases, a topside feeder 101 is shown in FIG. 13 with a bottomside inlet 102; whereas a side feeder 101 and inlet 102 are shown in FIG. 14. These four examples are also intended to demonstrate the various alternatives, here merely in the formation process, which may have particular impact on the ultimate calculations for a preferred outcome. Certain desirable outcome characteristics may make one or more of these alternatives more attractive in one scenario, and vice versa, depending upon which criteria may be more important in one or another application.

As mentioned above, various other alternative add-on modules may be found usable herewith, each such module taking into account particularly preferential characteristics or phenomena for the particular end-product, or the particularly desired procedure, inter alia. Examples hereof will be addressed hereafter.

Iron Add-On Module

Cast iron quality may be determined decisively by the applied melting practice, melt treatment and metallurgy. The prediction of feeding and micro structure formation during solidification and solid state transformation of cast irons may require an accurate consideration of the microscopic phase formation, the foundries actual melt analysis and the type and effect of melt treatment and inoculation. Microscopic kinetic growth models, which predict the type and amount of graphite formed, give an accurate simulation of competing graphite expansion and austenite contraction forces through which shrinkage or porosity are determined. This procedure also allows the prediction of the final microstructure and mechanical properties in the casting.

The output from coupling such an add-on iron module to the general simulation methodology is the information, which will be gained about:

The amount of grey and white iron in the different locations in a casting;

Eutectic cell size and lamella spacing for grey iron

Fraction of Austenite, primary graphite, eutectic and white iron phase;

Graphite nodule count for ductile iron;

Nodularity for CGI;

Cooling curves for any point of the casting showing the degree of undercooling, thermal recalescence and growth temperature as function of cooling rate and time;

The fraction of liquid at different stages of solidification;

Locates hot spots in the casting and the last areas to solidify;

Thermal modulus at any location in the casting;

Shrinkage and porosity formation in ductile iron, CGI and gray iron castings; and

Pearlite and ferrite distribution in the casting;

Distribution of hardness and mechanical properties (yield- and tensile strength, elongation at fracture, Young's modulus).

These data can via a link to conventional Finite-Element-load simulation software programs be used to improve the results of the load calculations. In this way the local variation in these data can be used instead of the conventional way of using homogeneous non varying data for the casting part domain as the initial and boundary conditions for the load calculation simulations

Steel Add-On Module

The concept is to provide extended capabilities to support the technical simulation of the manufacturing route for steel castings, form layout through the casting and heat treatment processes. The simulation capabilities are extended with numerical models to calculate velocities and pressure of the metal in both the liquid melt in the casting as well as in the mushy zone driven by thermal and solutal natural convection forces. The effect of this flow on the thermal map in the solidifying casting is taken into account. The calculated velocities are also coupled with a micro segregation model for the dendritic scale, to track the redistribution of the alloying elements in the alloy and predict macro segregation.

To model the final microstructure and related mechanical properties in the heat treatment process the heat transfer during the heat treatment process based on the changing conditions during austenitization, quenching and tempering is taken into account. This information, together with the alloy composition, is coupled through a regression analysis based on transformation diagrams for hundreds of steel grates. The analysis provides a prediction of the local microstructures and mechanical properties throughout the casting.

In the pre-production planning and methoding the foundryman may be supported with information like:

Volume and mass of the casting, machining allowances, gating system;

Riser system, mold sand, core sand and chills;

Fettling areas of the gating and feeding system;

Key quantities such as the sand/metal ratio and yield;

Modulus values for the complete casting and user specified feeding zones;

Ladle discharge rate and pouring time as a function of ladle geometry.

Additional information from the add-on module may include:

Velocity field in the casting due to both thermal and solutal natural convection;

Visualization of the movement of tracer particles through the melt during solidification;

Distribution of the alloy and trace elements throughout the casting (macro segregation).

Simulating the heat treatment process may give information about:

Temperature distribution in the casting after each heat treatment step;

Heating/cooling curves in the casting throughout heat treating cycles;

Alloy and austenitization condition dependent CCT diagram linked with quench cooling curves;

Martensite, bainite and ferrite/pearlite distributions in the quenched casting;

Hardness distribution in the quenched and tempered casting;

Yield strength, tensile strength end elongation distributions in the tempered casting.

Add-On Module for HPDC (High Pressure Die Casting) Process

The concept is to define and incorporate many if not all of the specific process parameters for this specific casting process, e.g.:

Ejection time (controlled by time or casting temperature);

Die opening sequence;

Delay time (simulating the effect of cycle interruptions on the thermal balance in the die);

Die closing sequence;

Lead time until beginning of the next cycle;

Individual control of each cooling or tempering channel (or channel loop);

Definition of die spraying procedure;

By the help of a shot curve calculator the die casting machine configuration for a specific casting geometry can be determined to give the optimal boundary conditions for the different shot phases to be used in the mold filling simulation.

The accurate filling simulation of the mold allows the identification of critical flow velocities, flow patterns, cold shots and critical areas for air entrapment. This information can be used to optimize the position and dimensions of runners, gates overflows and vents. The solidification and cooling off simulation can be used to establish the best cooling channel positioning and layout.

Add-On Module for LPDC (Low Pressure Die Casting) Process

The concept is to define and incorporate many if not all of the specific process parameters for this specific casting process to be able to make comprehensive simulation of fluid flow and casting quality, e.g.:

The die filling based on furnace temperature;

The feeding conditions in the casting during solidification taking into account the applied pressure in the furnace and resultant static pressure in the liquid phase in the casting and the influence of gravity as well;

The effect of individual cooling or heating channels as well as their control by time or a control thermocouple within the die or casting;

The effect of die spraying or coatings;

The influence of cores or inserts;

The effect of the sequence of die opening and closing through the individual control of each die section as a function of temperature or time.

Simulation with this add-on functionality may enable the foundryman in the following objectives:

Optimized filling of the mold cavity based on the applied pressure;

Optimal applied feeding pressure and its removal time;

Minimized die opening times;

The best cooling channel positioning and layout as a function of time or a thermocouple within the die;

Provide support for reduction of lead times and optimization of the entire processing cycle;

The reduction in the thermal loading of cores, inserts and die sections to maximize die life.

Plastic Injection Molding

This process is very similar to the HPDC process for metals, which was described above, so most of the technical issues are the same or similar. Again special one or more add-on functionalities to the general simulation systematic may be put in use to have the possibility to simulate this process with the production parameters, which are specific for this process. The viscosity for plastics (thermo-plastics) is much higher than for metals and another difference is that metals can be treated as incompressible in the casting process, but plastics on the other hand are compressible. This means that during the mold-filling phase of the casting process, it is possible, after the mold is filled with plastics, to inject, i.e., “fill in” more plastics by compressing the plastics already in the mold; a phenomenon, which may be simulated by the module hereof as well. In the cooling down process of thermo-plastics a specific phenomenon can take place; namely, surface shrinkage close to mass centers, a phenomenon which should be modeled with a special model. A peculiarity is often found with elastomers, wherein a hardening process takes place some time after the mold is filled with elastomer melt. This is a similar process to the solidification process for metals; however, even so, still other models have to be used to describe this process. It is more a chemical reaction where the solidification of metals is more of a physical process.

Add-On module for Stress/Strain and Distortion Simulations

Utilizing such a module, the stresses and strains developing during solidification, cooling off and heat treatment of castings can be calculated predicting the residual stresses and distortions generated in the final casting product. Machining allowances can be defined too so the redistribution of the stresses/strains and distortions after machining can be simulated as well.

These results can be linked to conventional Finite-Element-load calculation programs, and may thus be used to provide the starting condition (initial conditions) for the load calculation simulations for the specific casting. In this way more accurate load calculations can be carried out.

Other Casting Processes

Many different casting processes exist. For every process add-on modules may be implemented and used to specify the specific process parameters to simulate what is of specific technical interest for a given process. For investment casting processes, special attention has to be paid to radiation heat exchange. In the DISAMATIC casting process the heat transfer in the mold is of special interest, since the molds are stacked together, so a heat exchange between the molds may take place, which is incorporated, as well as the thermal deterioration of the sand to give input to the recycling process of the sand (sand plant). New developments in this process are “active up-hill bottom filling” of the molds using a pump or a pressurized furnace and “active feeding”, activating the feeders using compressed air. Again functionalities which can be specified in the add-on module may be taken into account in the simulations. For the Cosworth process, metal is pumped uphill into the molds, which has to be described to set the boundary conditions for simulating the mold filling process. Further in one variation of the process the molds are rotated after filling to enable the feeders to function by the use of gravity. Tilt casting processes and roll over processes rotate the molds during the filling process, which is taken account in the add-on module, so it is possible to carry out simulations of the filling process under such circumstances.

Still further simulation alternatives may be included. Hereafter for example, simulations of processes which are related to and/or supporting the casting processes are described.

Manufacturing of Core Boxes, Metallic Molds and Pattern Plates.

Based on the geometrical data for the geometry to be manufactured it can be modeled how to program the machinery, which are used for the manufacturing and in this way estimate the manufacturing effort needed. An aspect here is to use the simulated distortion results from the add-on module for stress/strain simulations to modify the geometry of the pattern plates, metallic molds and core boxes, so the final geometry of the cast product can be distortion free.

This information is used as a basis for the cost calculations, since in this way it will be know how much effort will be needed.

Core Shooting Process.

Models may be used herein/herewith for simulation of the flow of sand filling a core box, using equations similar to the equations used to simulate mold filling for the metallic melts and the plastic melts. Special attention though has to be to the fact that the core sands are particulate materials, which has to be reflected in the models. The results of such simulations provide information on where to place vents in the core boxes and also core box life time can be estimated using models to describe the wear by the sand flowing into the core boxes dependent on the core shooter process and the inlets for the sand.

Further the curing process can be simulated to find the way to carry out curing to have the shortest cycle time possible for producing cores.

Sand Mold Making Process.

The filling process for the sand filling and building up the mold is simulated the same way as for the core shooting process. Again the interest is the similar in finding the right position of the vents on a DISAMATIC pattern plate and to estimate the life time of a pattern plate, which can be related to the way the molding machine is producing the mold and in this way finding the different possible technical possibilities, which are the basis information necessary for the cost calculations.

Permanent Molds and Dies.

The lifetime is here estimated by modeling the oscillating stresses and strains during the casting cycles, generated by the oscillating temperature fields due to the heat input from the castings, which has to be cooled away by typically cooling pipes. So during the lifetime fatigue will take place and destroy the mold/die determining the lifetime (faults like heat checkings). This information is used for the cost calculations.

Fettling.

This process is cleaning the casting after being removed from the mold/die and removing the ingate system and risers. Different ways of doing this independent of the casting layout is the input for the economical calculations.

Machining.

After fettling the casting is now ready for machining. The technical implication of the different designs has to be considered/modeled to be able to make the cost calculation.

Heat Treatment.

The way to simulate the technical aspects of this process has already been described in the section “Steel add-on module” above. These technical data are used to make the cost calculations.

Surface Treatment.

The technical implication of the different designs has to be considered/modeled to be able to make the cost calculation.

Coupling Design Analyses with Casting Analyses.

Also disclosed herein are methods or systems for optimising local casting properties to meet the required local demands on component performance. Such may be accomplished using an integrated virtual optimization tool for casting process and design optimization. These methods or systems may be provided via a computer implemented process that couples quantitative casting property predictions resulting from different in-situ processes and casting design optimization loops to the optimization of local material requirements during component design, thereby generating a casting or component design which adjusts the local casting properties to the component's performance demands.

Previously, the optimization of casting component design has neglected consideration of local material property variations that may result from casting processes. On the other hand, casting process optimization has not considered the local requirements on the cast component's performance in terms of static or dynamic loads. Computer implemented analyses of both casting processes and component design have been carried out independently of one another. This will often have resulted in a design or conditions optimised for either the casting process or for the component's design only. Neglecting interactions between both optimisation loops may result in either conflicting solutions or in inferior use of the material's full potential.

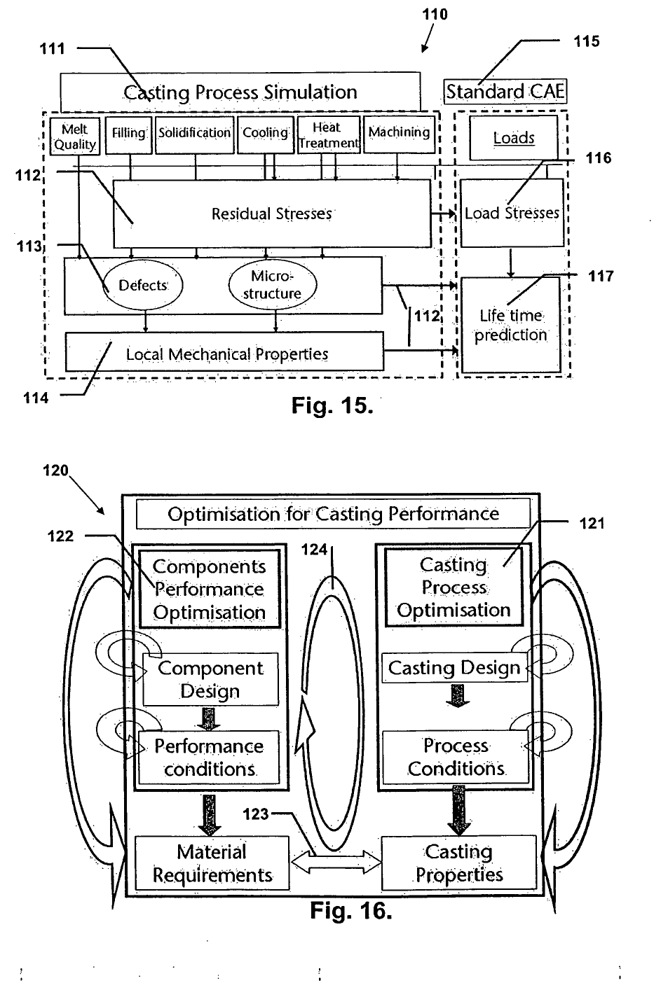

According to an embodiment hereof, both the casting process and the design will be integrated to produce superior component designs. With reference to FIGS. 15 and 16, different elements for carrying out a numerical optimization of an entire casting design process chain according hereto is illustrated. FIG. 15 generally includes a combination 110 of a casting process 111 with a design process 115; whereas more particularly, the main steps of such an optimisation are the following:

Use of physical based simulation methods to predict the entire casting process including consideration of melt quality, mold filling, solidification, cooling and subsequent processes such as heat treatment or machining, process 111.

Use of simulation methods to quantitatively predict local casting properties, such as dendrite arm spacing, structures, porosities, and residual stresses as a function of casting design and casting process conditions, analysis parts 112, 113.

Use of simulation methods to quantitatively predict local mechanical properties as a function of the above casting properties, analysis part 114.

Further Included Are:

Use of in-situ optimization loops for casting design and casting process conditions to be able to predict and adjust local casting properties, FIG. 16, sub-process 121.

Use of simulation methods to design casting components FIG. 15, process 115, as a function of performance requirements, such as static loads, analysis part 116, and dynamic loads, analysis part 117.

Use of design optimization methods to optimise the component's shape based on the determined local load conditions, FIG. 16, sub-process 122.

Method to link the information of local casting properties with performance simulation analyses, FIG. 16, part 123.

Use of optimisation methods to adjust one or more of component shape, casting process conditions or casting design in order to achieve a match between the local components material requirements and the local casting properties, FIG. 16, part 124.

### EXAMPLE

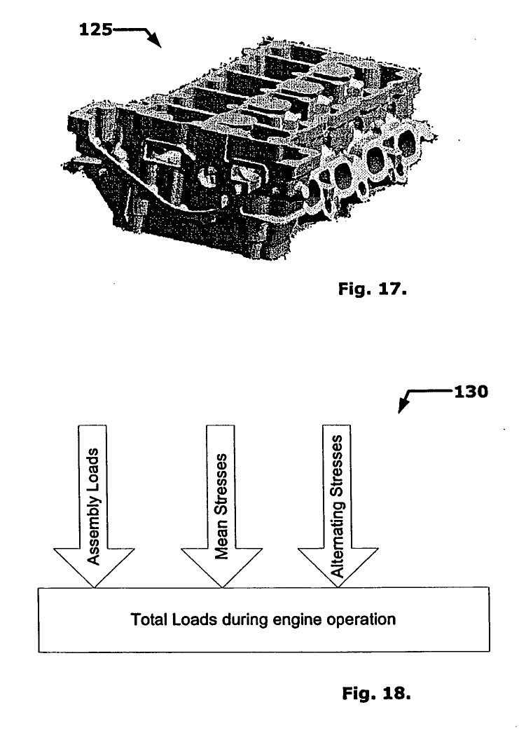

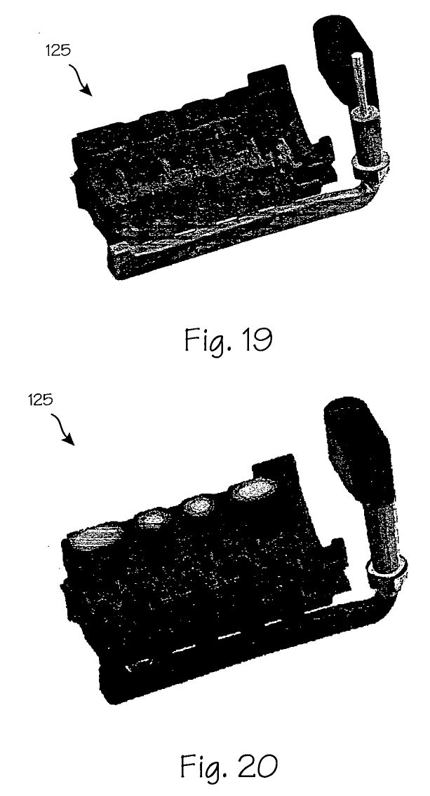

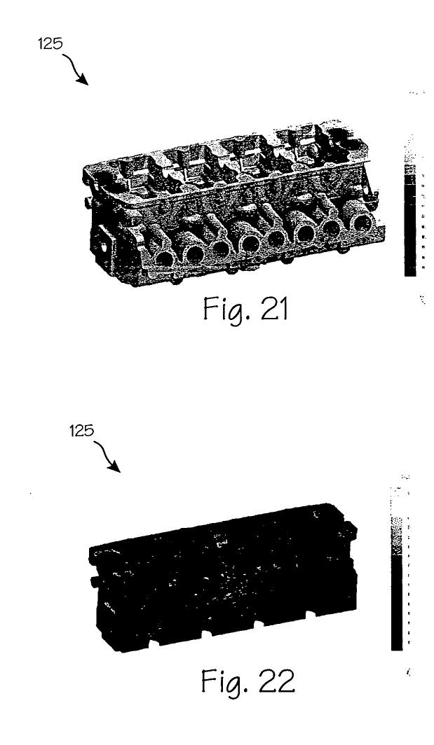

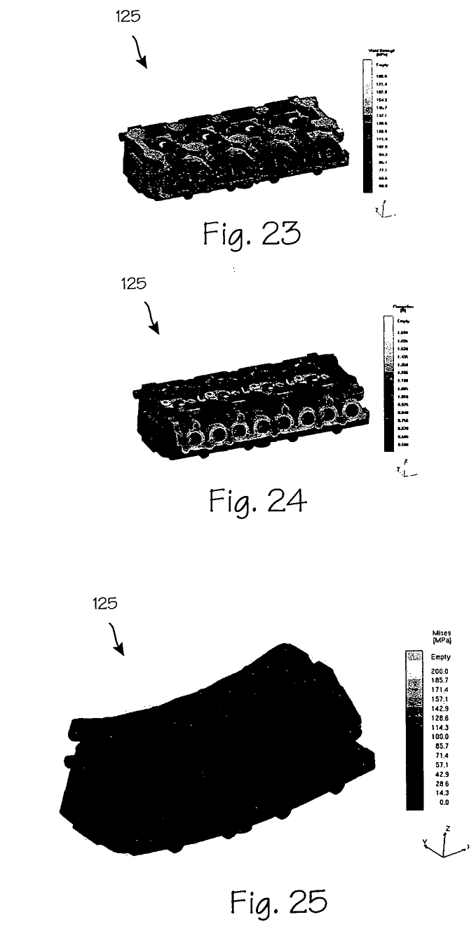

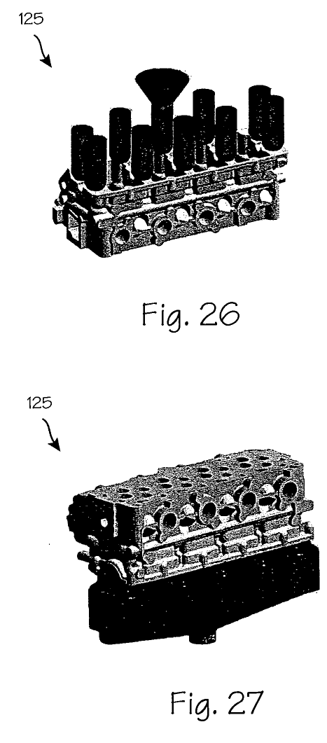

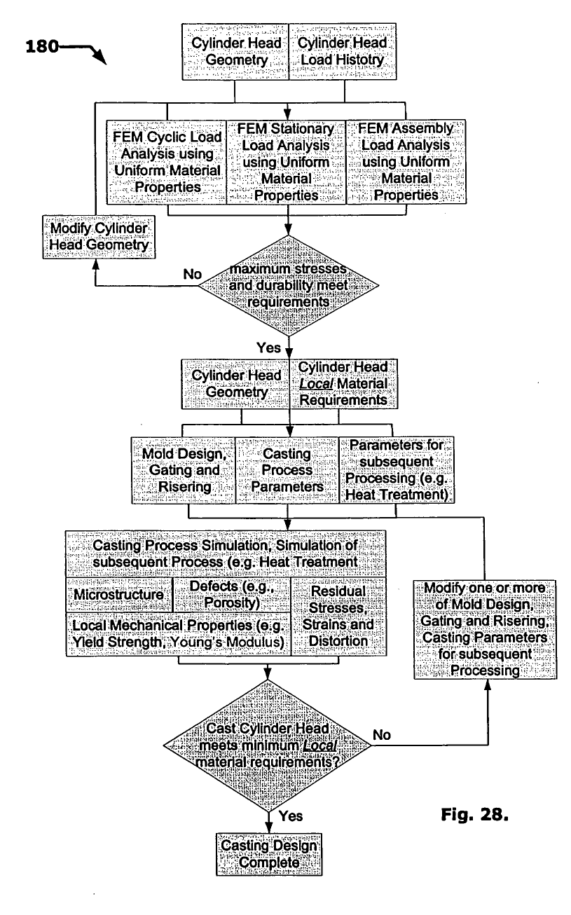

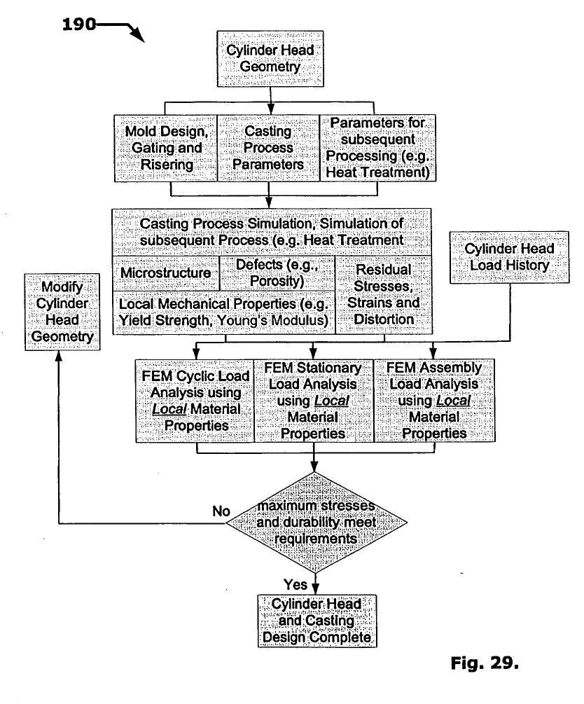

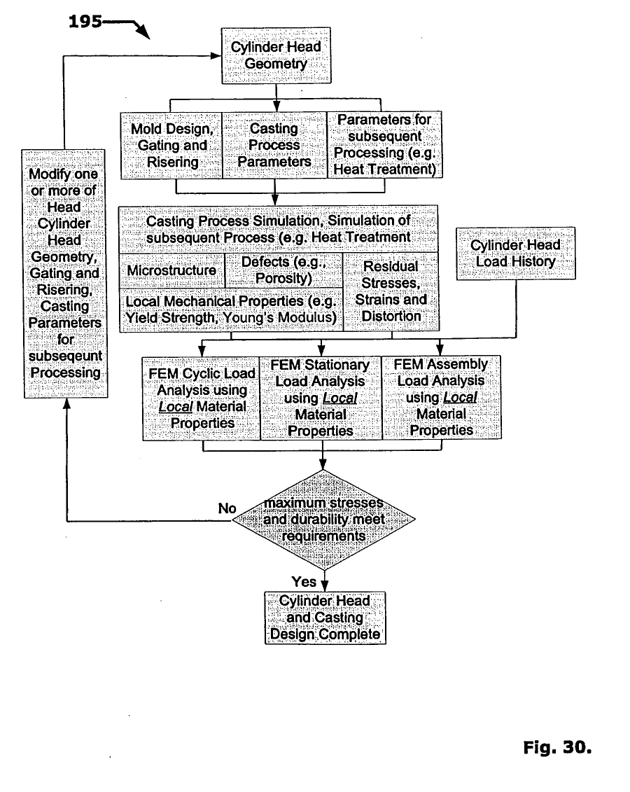

In an example hereof, a cylinder head 125, see FIG. 17, may be used as a cast component to be evaluated. Such a component may typically be produced in Aluminium alloys by sand or permanent mold casting processes. Due to its function, the component is subject to static and alternating loads of different kinds during operation. Several exemplar steps of a process hereof follow hereafter.
1. The requirements for the design of a cylinder head 125 may first typically be identified through a complex load analysis of static, thermal or alternating loads, which represent the actual conditions during operation of the engine, see e.g., FIG. 18.
2. The design of a cylinder head 125 may then be subjected to a systematic and at times complex analysis in order to determine a component geometry which fulfils the strength and endurance demands as identified in step 1. Note, geometrical modifications are typically used as the sole degree of freedom to meet the required strength of the component. In other words, the component geometry may be iteratively changed (in this step 2) until the stress levels and durability meet the requirements (identified in step 1). In this iterative optimisation process, the material performance resulting from its internal structure or the applied manufacturing process may be considered to be isotropic and uniform.
3. The manufacturing process of cylinder heads may include multiple stages in which the structure and resulting performance of the material may be influenced in particular by the preparation of the melt, the casting process, the local conditions during solidification and cooling as well as a subsequent heat treatment often applied to establish improved mechanical properties. Thus, during the design of the casting process, the requirements for mold design, gating and risering, as well as process conditions may be identified through a complex analysis of the entire process. Main steps and conditions to be considered may be melt quality, mold filling (FIG. 19), solidification and cooling (FIG. 20), subsequent heat treatment and machining. This analysis delivers information about the distribution of the micro-structures (FIG. 21) and defects (FIG. 22) such as porosities in the cast part.
4. This information (micro-structures, FIG. 21 and defects, FIG. 22) may be used to influence the final local mechanical properties (tensile, yield strength and elongation) in the component as illustrated in FIGS. 23 and 24. In parallel, the inhomogeneous cooling of the cast component during either casting or heat treatment may result in a thermally induced stress distribution (shown in FIG. 25), which contributes to the total component load during operation. Note the residual stresses as well as local defect and structure distribution contributes to the total durability of the component, as these are shown and described in FIG. 15, process flow 118.
5. During the optimisation of the production process, the foundry expert has the flexibility to iteratively change mold geometry, gating and risering design and process conditions for the casting and heat treatment stages, see FIGS. 26 and 27. In this iterative optimisation process as described in FIG. 16, part 121, the casting material's performance may be designed to meet the minimum and uniform material standard specifications in all areas throughout the component.
   Through the innovative coupling of these two design optimization methodologies, two new optimisation pathways are possible:
A) From the component design analysis and optimization, see step 2, the local material requirements in all parts of the cylinder head are known. This information can be used as the objective to be matched by the local material properties to be achieved through the casting process design optimization loop of pathway 180, see FIG. 28.
B) From the casting process design analysis and optimization, see step 4, the local casting properties in all parts of the cylinder head are known. This information can be used in place of the isotropic and uniform properties as described in step 2 resulting either in potential component weight reduction or performance improvement, see pathway 190 in FIG. 29. Further to this option B, an innovative global optimization methodology is proposed where the casting's design as well as the component's design is integrated into an iterative optimization loop in order to simultaneously determine the optimal component design (based on local casting properties) and the optimal casting process (based on the local material requirements), see pathway 195; FIG. 30.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A method for optimizing a process for producing a cast or molded product made by one or more production steps comprising:
defining one or more technical requirements for the cast or molded product;
providing a first computer implemented process that reflects the one or more production steps for producing the cast or molded product;
generating with the computer implemented process one or more first solutions that will lead to the cast product fulfilling the technical requirements using the one or more production steps;
displaying the one or more first solutions to a user on a display;
optionally selecting an economic data requirement having an optimal value and selecting at least one of the one or more first solutions;
determining in a second computer implemented process which combination of the selected one or more first solutions results in the economic data requirement being closest to the optimal value resulting in a second solution subset of the one or more first solutions; and
displaying the subset to the user.

2. The method of claim 1 wherein the economic data requirement is selected from the group of economic data requirements consisting of manufacturing cost, material consumption and environmental load.

3. The method of claim 1 wherein the step of defining one or more technical requirements includes providing a digital representation of the geometry of cast or molded product.

4. The method of claim 1 wherein the step of generating one or more solutions further comprises:
analyzing the final cast or molded part load requirements;
modifying the design of the cast part to meet the load requirements;
performing cast process analysis; and
using the information from the cast process analysis to modify one or both of the load requirements and the design of the cast part.

5. The method of claim 1 wherein the step of generating with the computer implemented process one or more first solutions includes simulating a molding process or casting process.

6. The method of claim 1 wherein the step of generating with the computer implemented process one or more first solutions includes performing a technical analysis selected from the group of technical analysis consisting of a thermal analysis, a mechanical analysis and a thermophysical analyis.

7. A system comprising:
a processor; and
a memory operably coupled to the processor, the memory containing program code that, when executed by the processor, causes the processor to:
request a user to define one or more technical requirements for a cast or molded product;
generate one or more first solutions with each solution reflecting one or more production steps that will lead to the cast or molded product fulfilling the technical requirements;
display the one or more first solutions to the user on a display;
request the user select an economic data requirement having an optimal value and select at least one of the one or more first solutions; and
determine which combination of the selected one or more first solutions results in the economic data requirement being closest to the optimal value resulting in a subset of the one or more first solutions; and
display the subset to the user.

8. The system of claim 7 wherein the economic data requirement is selected from the group of economic data requirements consisting of manufacturing cost, material consumption and environmental load.

9. The system of claim 7 wherein the user may define one or more technical requirements by providing a digital representation of the geometry of cast or molded product to the processor.

10. The system of claim 7 wherein one or more first solutions are generated by:
analyzing the final cast or molded part load requirements;
modifying the design of the cast part to meet the load requirements;
performing cast process analysis; and
using the information from the cast process analysis to modify one or both of the load requirements and the design of the cast part.

11. The system of claim 7 wherein one or more first solutions are generated by performing a technical analysis selected from the group of technical analysis consisting of a thermal analysis, a mechanical analysis and a thermophysical analyis.

12. A computer program article for performing casting or molding simulations and one or more production step simulations on a cast or molded product represented by digital data, the computer program article tangibly embodied in a computer-readable medium or propagated signal, the computer program article comprising instructions operable to cause a programmable processor to:
request a user define one or more technical requirements for a cast or molded product;
generate one or more first solutions with each solution reflecting one or more production steps that will lead to the cast or molded product fulfilling the technical requirements;
display the one or more first solutions to the user on a display;
request the user select an economic data requirement having an optimal value and select at least one of the one or more first solutions; and
determine which combination of the selected one or more first solutions results in the economic data requirement being closest to the optimal value resulting in a subset of the one or more first solutions; and
display the subset to the user.

13. The computer program article of claim 12 wherein the economic data requirement is selected from the group of economic data requirements consisting of manufacturing cost, material consumption and environmental load.

14. The computer program article of claim 12 wherein the user may define one or more technical requirements by providing a digital representation of the geometry of cast or molded product to the processor.

15. The computer program article of claim 12 wherein one or more first solutions are generated by:
analyzing the final cast or molded part load requirements;
modifying the design of the cast part to meet the load requirements;
performing cast process analysis; and
using the information from the cast process analysis to modify one or both of the load requirements and the design of the cast part.
